(19) United States
(12) Patent Application Publication
(10) Pub. No.: US 2006/0112340 A1
(43) Pub. Date: May 25, 2006

(54) Portal page conversion and annotation

(76) Inventors: Julia Mohr, Edingen-Neckarhausen (DE); Michael Danninger, Landau (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/995,052

(22) Filed: Nov. 22, 2004

(51) Int. Cl. G06F 9/00

(52) U.S. Cl. 715/733; 715/762; 715/760

(57) ABSTRACT

Methods and apparatus, including computer program products, for displaying a portal page in a first graphical user interface window, the portal page including a content area for providing a view of an item of portal content associated with the portal page, wherein at least one other view of the item of portal content is not provided in the content area, applying one or more conversion rules to the portal page to generate an electronic document, and displaying the electronic document in a second graphical user interface window, wherein more than one view of the item of portal content is provided in the electronic document.

### BACKGROUND

This description relates to portal page conversion and annotation.

A portal brings together various applications from an intranet and extranet that may or may not be related to one another. Traditional portal software products include portal development tools for creating portal templates that are used at portal runtime to generate portal pages for display. Runtime portal templates, including those implemented using Java Server Pages (JSP) and custom tags, provide an efficient way to combine static data with dynamic runtime data for presentation to a user in a portal environment.

Technical support is sometimes required for users of a portal. This technical support may be to correct or diagnose a fault that occurs when the user interacts with the portal or to provide guidance, educate or enhance the user's experience while interacting with the portal.

A variety of approaches currently exist to provide technical support. The most effective, but most costly approach is on-site support, in which a technical support agent visits the premises of the customer/user and works directly with the user on the user's computer. Another approach is for the user to call a help desk call center and speak to a technical support agent. It is often difficult for a user to explain what the problem is. Further, if there are a number of error messages displayed on the user's display screen, it may take a significant amount of time for the user to read the error messages to the technical support agent.

To enable the technical support agent to view the portal page displayed on a user's display screen, the user can employ a screen capture application to obtain screen shots, which may be subsequently sent as attachments of an email to the technical support agent. Screen shots have the limitation of capturing only the content that is displayed on the user's display screen when the screen shot is made. Hence, multiple screen shots may be required if the content spans multiple screens or is hidden for a particular view. Another option is for the user to print the portal page using an Adobe® PDF Writer, and to send a resulting Adobe PDF (Portable Document Format) document as an attachment to the technical support agent. For both of these options, the user is limited in his/her ability to exclude the parts of the screen, e.g., a portal header and a detailed navigation section, that are not interesting or otherwise necessary for the technical support agent to troubleshoot the problem or error encountered by the user.

Another option to allow a technical support agent to view the portal page is for the user to click on a “Show Print Version” or “Printer Friendly Version” link displayed in the portal page in order to bring up the content in a printer-friendly layout. The print-friendly content may be sent as an attachment of an email to the technical support agent. For this option, each portal page that provides such “print friendly” functionality has to include lines of code within its template to format the displayed content in a printer-friendly format.

### SUMMARY

In one aspect, the invention is directed to a method for displaying a portal page in a first graphical user interface window, the portal page comprising a content area for providing a view of an item of portal content associated with the portal page, wherein at least one other view of the item of portal content is not provided in the content area; applying one or more conversion rules to the portal page to generate an electronic document; and displaying the electronic document in a second graphical user interface window, wherein more than one view of the item of portal content is provided in the electronic document. Corresponding computer programs and apparatus are also provided, along with one or more of the following features.

All of the views of the item of portal content may be provided in the electronic document. The portal page may be defined by a portal page template including a plurality of structure elements. At least one conversion rule may be associated with a structure element, and the method may include identifying structure elements associated with the items of portal content provided in the content area of the portal page, and redefining the identified structure elements based on corresponding conversion rules.

The first graphical user interface window may be a Web browser window and the second graphical user interface window may be an application window. The second graphical user interface window may include one or more editing tools, and the method may include receiving, from a user, an input action to use one or more editing tools to add one or more annotation tags to the electronic document displayed in the second graphical user interface window. At least one annotation tag may be drawn from a predefined set of tags comprising a text annotation tag, a line annotation tag, a square annotation tag, a circle annotation tag, a highlight annotation tag, an underline annotation tag, a strikeout annotation tag, and a popup annotation tag. The method may include receiving, from the user, an input to take an action with respect to the electronic document, and in response to the input, performing at least one of saving the electronic document, emailing the electronic document, and printing the electronic document.

In general, in another aspect, the invention is directed to a method for generating a portal page, the portal page including a content portion and a non-content portion, converting the content portion to an electronic document, and making the electronic document available to a technical support agent. The method may include annotating the electronic document prior to making the electronic document available. Corresponding computer programs and apparatus are also provided.

Advantages that can be seen in particular implementations of the invention include one or more of the following. The conversion agent enables a user to select a portal page having relevant content to be shared with another person, and generate a file that makes visible multiple views of the content provided in a content area of the portal page, while excluding the parts of the screen, e.g., a portal header and a detailed navigation section, that are not interesting or otherwise necessary for the technical support agent to troubleshoot the problem or error encountered by the user. The file can be generated in response to a single mouse click of a button or link. The conversion agent also provides editing functionality that enables a user to directly annotate the generated file. In a help desk context, this enables the user to share information with a technical support agent by directly referencing the portions of the content provided in the generated file. This reduces the amount of time and effort needed for the user to describe the encountered error(s), and allows the technical support agent to gather enough information to determine the context and likely cause of the error without having to rely solely on the user's description.

The details of one or more examples are set forth in the accompanying drawings and the description below. Further features, aspects, and advantages of the invention will become apparent from the description, the drawings, and the claims.

### DESCRIPTION OF DRAWINGS

FIG. 1 shows a portal-based networked environment.

FIG. 2 shows an example portal page.

FIGS. 3a-3e each show an example problem ticket file.

### DETAILED DESCRIPTION

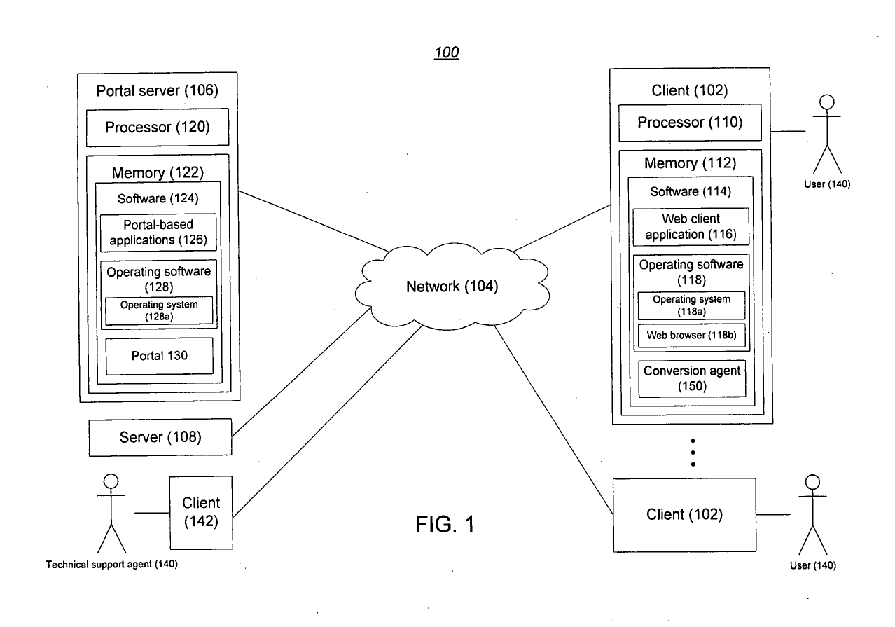

FIG. 1 shows a portal-based networked environment 100 including a client 102. The client 102 may be any type of Web-enabled apparatus or system. Examples of such apparatuses or systems include, but are not limited to, a desktop computer, a laptop computer, a mainframe computer, a cellular telephone, a personal digital assistant (“PDA”), and a controller embedded in an otherwise non-computing device.

The client 102 may be connected to an internal network, such as a local area network (“LAN”). A router or gateway (not shown) may couple the internal network to an external network, such as the Internet/World Wide Web. Alternatively, the client 102 may be coupled directly to the external network 104 as shown in FIG. 1. The external network 104 runs transmission control protocol/internet protocol (“TCP/IP”) or another suitable protocol. Network connections may be via Ethernet, telephone line, wireless, or other transmission media.

The client 102 contains one or more processor(s) 110 (referred to simply as processor 110″) and memory 112 for storing software 114. The processor 110 executes software 114, which includes Web client application 116 and operating software 118. The client application 116 includes one or more routines used in implementing the TCP/IP protocol, which allows the client 102 to communicate over the external network 104. The operating software 118 may include an operating system 118a, such as Windows XP®, a Web browser 118b, such as Internet Explorer®, and various application programs.

A firewall may be present between the internal network and the external network 104. The firewall may be implemented by software on the client 102 or by software on a gateway, router, or the like (not shown) between the internal network and the external network 104.

The external network 104 may be comprised of one or more networks, such as wide area networks (“WANs”), LANs, wireless networks, and the like, which may or may not be linked by the Internet. The external network 104 may include one or more remote computers 106, 108, which are programmed with software to host and support a portal. Although only two remote computers are shown in FIG. 1, any number of remote computers may be provided. The remote computers may be on the same, or different, networks.

The remote computers 106, 108 may be any type of computing devices (e.g., servers), and may have the same or different architectures. For the purposes of the present description, it is assumed that the remote computer 106 is a portal server that includes one or more processor(s) 120 (referred to simply as processor 120) and memory 122 that stores software 124. The processor 120 executes software 124, which includes portal-based applications 126 and operating software 128. The operating software 128 includes, but is not limited to, an operating system 128a and one or more routines for effecting (e.g., TCP/IP-based) communication over the external network 104.

The portal server 106 provides a common interface for the portal-based applications 126 through a Web site access point (referred to simply as portal 130). The portal 130 receives requests from the client 102 and uses portal templates to generate information views e.g., Web pages, in response. The portal 130 can implement a user-roles based system to personalize the common interface and the information views for a user 140 of a client 102. The user-role may be the user's function within an organization. For example, the user 140 may be a programmer, a sales manager, and a supervisor, to name a few. The user 140 can have one or more associated roles that allow personalize tailoring of a presented interface through the generated information views. The portal 130 can receive information from the portal-based applications 126 to fulfill requests from the clients 102.

The portal 130 can be integrated with an enterprise management system that consolidates multiple application services. The integrated enterprise management system can provide integrated application services to manage business objects and processes in a business enterprise. The business objects and processes can be resources, e.g., human resources, development projects, business programs, inventories, clients, accounts, business products, and/or business services. The integrated enterprise management system can also include an integration tool, such as SAP Exchange Infrastructure available from SAP AG of Walldorf (Baden), Germany. Such an integrated enterprise management system consolidates and integrates data and functionality of multiple different applications into a single enterprise management tool provided through the portal 130. The applications can be many types of information sources, including Web services, document repositories, and/or enterprise based systems, such as human resource management systems, customer relationship management systems, financial management systems, project management systems, knowledge management systems, business warehouse systems, time management systems, and electronic file and/or mail systems.

The portal 130 can be developed using a portal software product that includes out-of-the-box portal templates and portal development tools that enable a portal developer and/or administrator to create portal templates. Each portal template defines the structure of a portal page through the use of structure elements, e.g., traditional HTML tags and/or custom tags defined in a tag library. Each item of portal content to be displayed in a portal page associated with a portal template is assigned a structure element and is either static content or dynamic content. The term “static content” refers to items of portal content with run-time behavior that is generally determinable at design time, including images, text, and HTML components, including server-side or client-side code/scripts that result in dynamically generated content on a page. The term “dynamic content” refers to items of portal content with run-time behavior that is not readily determinable at design-time because the content comes from a dynamic content source, such as an application database, and the content may be personalized based on a current user of the portal and any associated roles for that user.

In one example, the custom tags correspond to a markup language called HTMLB (HTML-Business for Java), which is provided by SAP AG of Walldorf (Baden), Germany. HTMLB provides a full set of easy-to-use Web controls, each having attributes that define the appearance of the Web control on a display screen. Such attributes may be set by a portal developer to define a default appearance of the Web control. In some instances, the default appearance of a Web control provides a single view of content. The user may switch between several views of content by selectively manipulating the content via, e.g., actuating buttons of the Web control.

One example of a HTMLB Web control is the <TableView> Web control for arranging data (e.g., text, images, links, other tables etc.) into rows and columns in a tabular fashion. The attributes of the <TableView> Web control can be set by the portal developer to define the size of the table, to provide navigation buttons for scrolling vertically through the rows of the table, and to provide for single or multiple selection of rows through the use of radio buttons or checkboxes. Other example HTMLB Web controls include a <Breadcrumb> Web control, a <Button> Web control, a <Chart> Web control, a <Checkbox> Web control, a <DateNavigator> Web control, a <DropDownListBox> Web control, a <FileUpload> Web Control, an <InputField> Web control, an <ItemList> Web control, a <Label> Web control, a <RadioButton> Web control, a <TabStrip> Web control, and a <TextEdit> Web control to name a few.

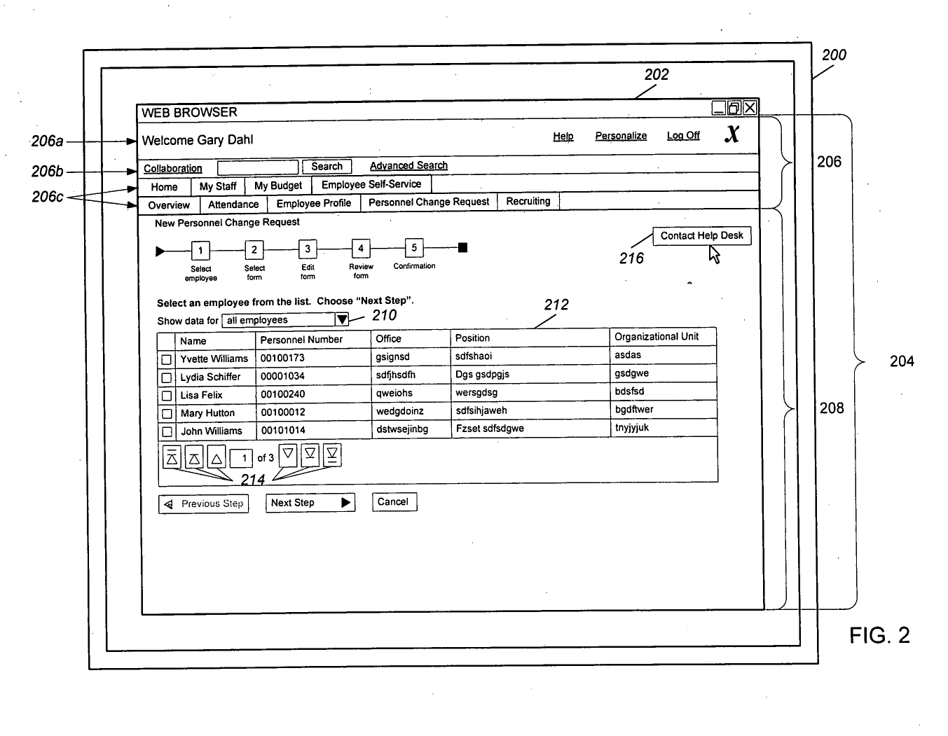

In one example scenario, Company X provides a portal 130 through which its employees interact with portal-based applications 126. FIG. 2 shows an example of a portal page 204 that is rendered and presented in a Web browser window 202 on a display screen associated with 200 a client 102 when a manager by the name of “Gary Dahl” at Company X logs in to a portal account that has been personalized based on his identity and role at Company X.

The portal page 204 is conceptually partitioned into a header area 206 and a content area 208. The header area 206 of the portal page 204 includes a masthead 206a, a tools area 206b, and a two-level navigation tab strip 206c. The masthead 206a contains branding elements (e.g., the “X” logo), a user identifier (e.g., “Gary Dahl”), and the appropriate (based on the portal configuration) function links from among “Help”, “Personalize”, and “Log off”. The tools area 206b provides access to applications, such as a collaboration component and a search component. Applications may vary based on the company and user. The two-level navigation tab strip 206c displays a set of first-level tabs (e.g., “Home”, “My Staff”, “My Budget”, and “Employee Self-Service”) and a set of second-level sub tabs of navigation (e.g., “Overview”, “Attendance”, “Employee Profile”, “Personnel Change Request”, and “Recruitment”). The tab strips 206c allow the user to switch between several views of content by clicking on the tabs. The views appear to share the same portal content area on the user's display screen. The user can access a particular view by clicking its tab.

The content area 208 of the portal page 204 provides items of portal content, each having a relative position in the portal page that is defined by a structure element of the portal template. In this example portal page 204, the content area 208 includes a number of portal content items assigned to HTMLB Web controls, e.g., a <DropDownListBox> Web control for providing a drop down list of box items 210 including “All Employees”, and a <TableView> Web control for providing a table of information identifying members of Gary Dahl's team. In this case, the portal developer set the attributes of the <TableView> Web control such that the default appearance of a table 212 makes visible only five rows of information at a time. The user (i.e., Gary Dahl) can scroll through the rows of the table using scrolling buttons 214 to make visible information associated with other members of his team. That is, the user can use the scrolling buttons 214 to cause different views of the content (in this case, the information about the members of Gary Dahl's team) to be displayed in the table 212.

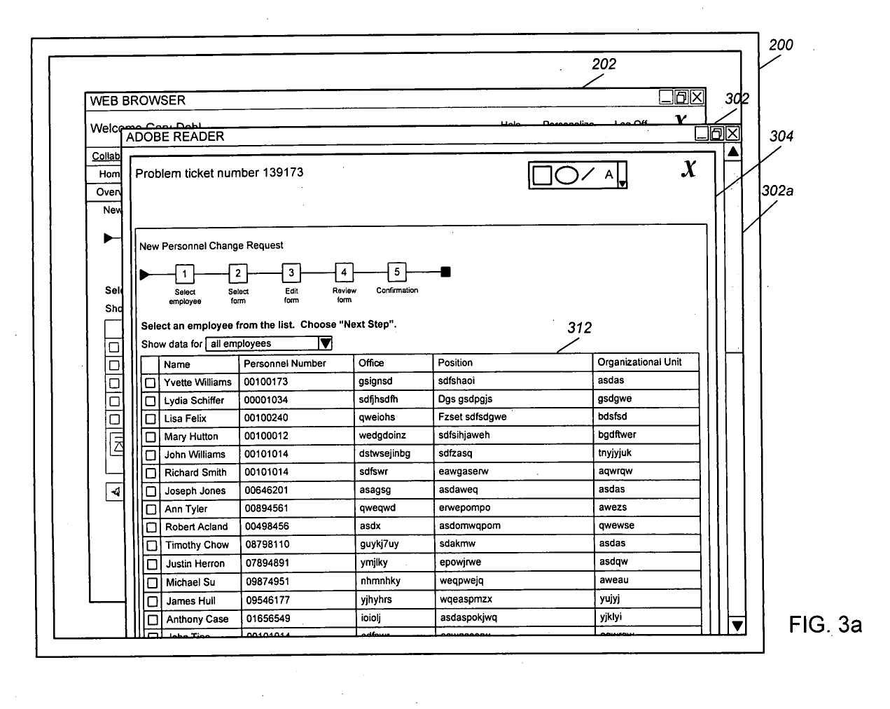

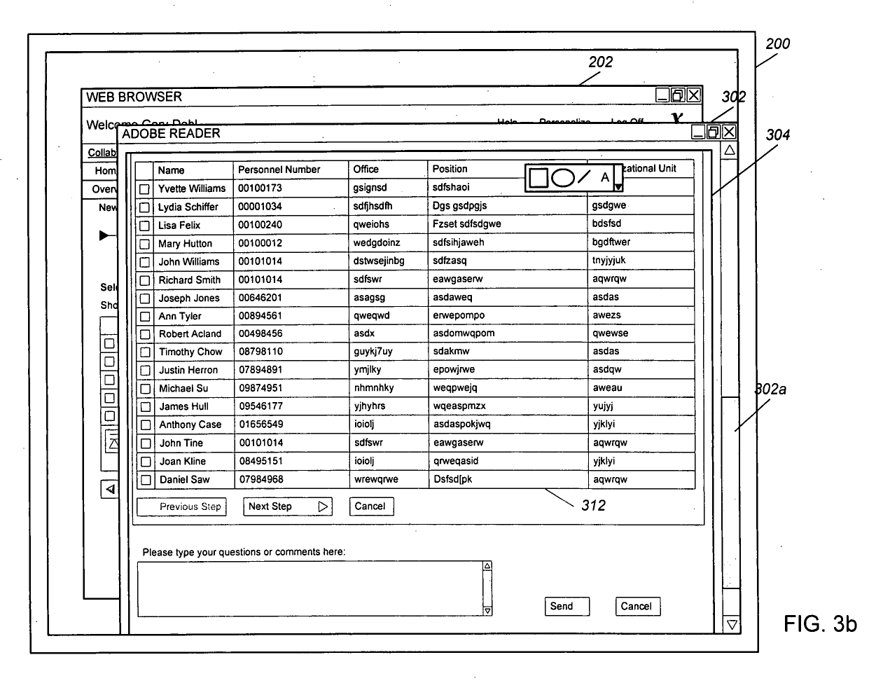

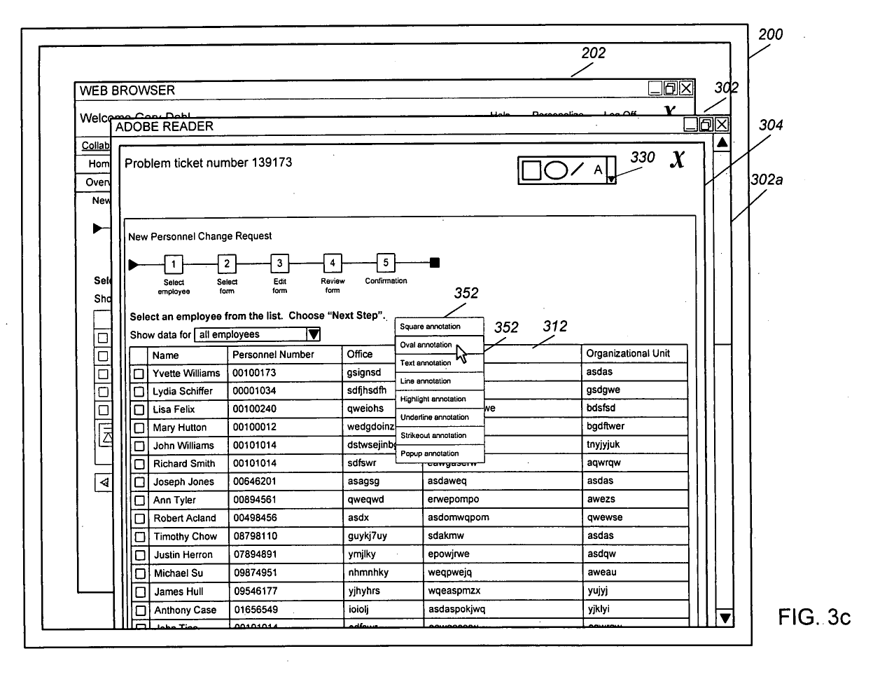

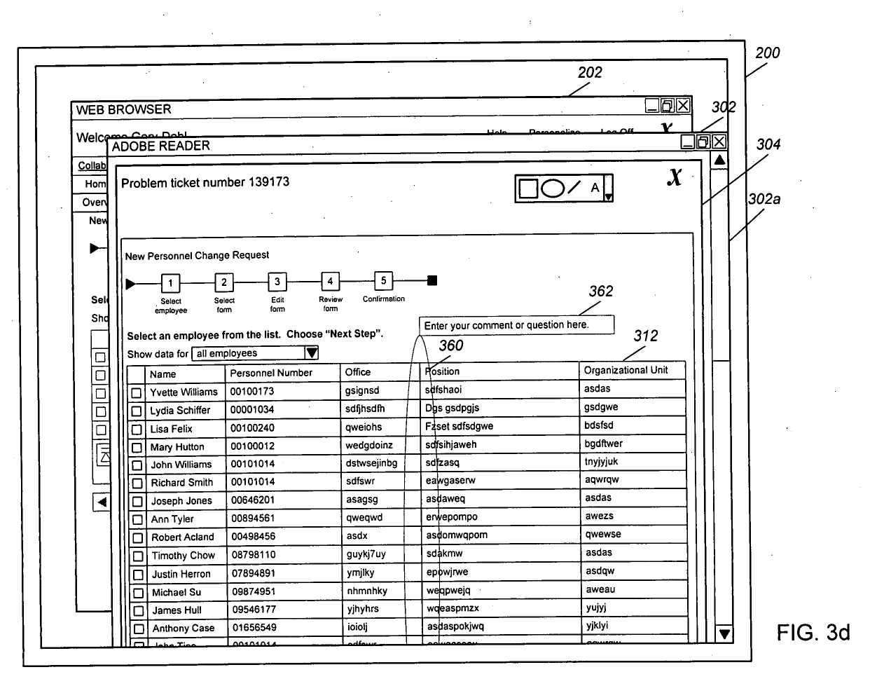

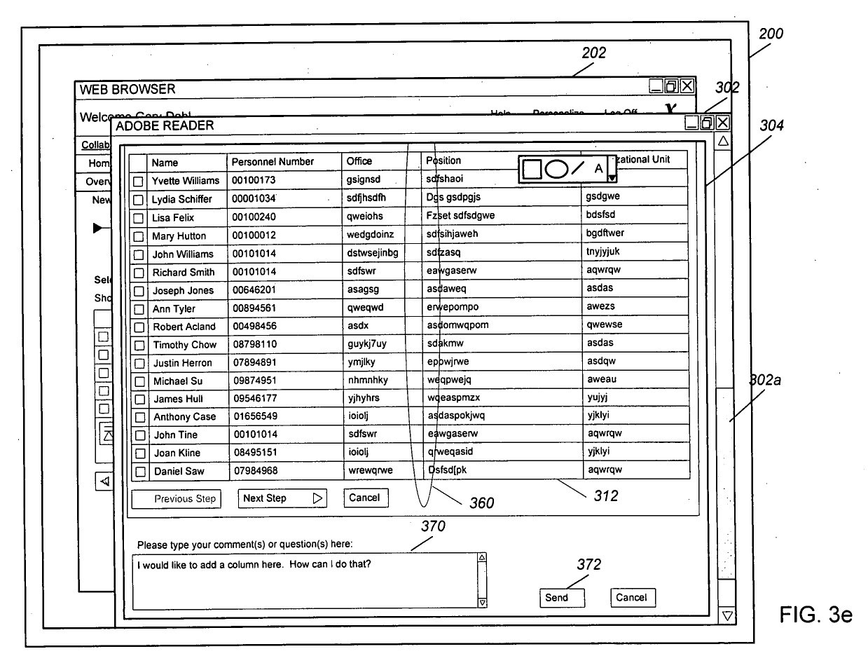

Suppose, for example, that the user interacting with the portal page 204 is unsatisfied with the “look” of an item of portal content that is displayed on the portal page 204. In this case, the user creates a problem ticket by clicking on a “Contact Help Desk” button 216. This user action causes a software agent (“conversion agent” 102b), running on the client. 102 (i.e., the user's computer) or at a remote location, to apply a set of conversion rules to the portal page 204 and generate a problem ticket file (“generated problem ticket file” 304) that is displayed in a separate application window 302 or the display screen 200, as shown in FIG. 3.

In one implementation, the conversion agent 150 examines the portal template defining the structure of the displayed portal page 202 to determine the manner in which each structure element, e.g., traditional HTML tag and/or custom tag associated with the content area 202 of the portal page 202, is to be resolved. The conversion agent 150 stores or otherwise has access to a library of conversion rules. When applied, each conversion rule converts an item of portal content from its default format to an “exploded view” format by changing one or more attributes of its associated web control. One example conversion rule involves changing an attribute of the <TableView> Web control for providing the table 212 that includes scrolling matters 214 a table 312 without any type of scrolling mechanism. As shown in FIG. 3a, the table 312 includes rows of information associated with all of the members of Gary Dahl's team. This is in contrast to the table 212 of FIG. 2 in which only five rows of information are visible at a time. Depending on the size of the application window 302 in which the generated problem file ticket 304 is displayed, it may be necessary for the user 140 to use the application window's scrollbar 302a to view different portions of the table 312 in its exploded view format as shown in FIG. 3b.

In one implementation, the conversion agent 150 automatically includes as metadata of the generated problem ticket file a ticket number, user identifier, date, and time. The conversion agent 150 may be further implemented to gather information on the system settings, such as the make and model of the user's computer, type and version number of the operating system, type and version number of the Web browser, hardware installed, network settings, interrupt settings and other software applications installed on the user's computer 102. This information can be forwarded to a server 108 where it is held in a system summary file that the technical support agent 142 can access when responding to the problem ticket. In the alternative, this system setting information can be stored as metadata associated with the generated problem ticket file or visible within the generated problem ticket file itself.

In one implementation, the generated problem ticket file 304 is an Adobe® PDF compatible file that can be displayed in an application window of Adobe® Reader® software available from Adobe Systems Incorporated. The conversion agent 150 provides editing functionality independent of any editing functionality provided by, e.g., the Adobe Reader software. In one example, the conversion agent 150 provides a set of editing tools in a floating tool bar 330 displayed in the viewing area of the application window 302. The floating tool bar 330 provides a number of annotation tags that may be used by the user to mark up the generated problem ticket file. In one example, each annotation tag is drawn from a predefined set of tags including a square annotation tag 330a, an oval annotation tag 330b, a line annotation tag 330c, a text annotation tag 330d, a highlight annotation tag, an underline annotation tag, a strikeout annotation tag, and a popup annotation tag.

To mark up the generated file, the user 140 can drag-and-drop an oval annotation tag 330b from the floating tool bar 330 to a relevant place in the displayed problem ticket file 302. In another example shown in FIG.3c, the user 140 can right-click a mouse button, select an “oval annotation” option 350 from a pop-up menu 352, and mark the relevant place in the displayed generated problem ticket file by drawing an oval while holding down the left mouse button. In the implementation illustrated in FIG. 3d, a comments box 362 is automatically attached to the oval 360 with an instruction of “Enter your comment or question here”. Such an annotation process may be repeatedly performed throughout the generated problem ticket file 302. In this manner, the user 140 can directly reference the problem areas or areas of interest to a technical support agent 142 without having to provide the context for the encountered errors or issues, or recreate the error messages. In the implementation illustrated in FIG. 3e, the user 110 can use the application window's scrollbar 302a to scroll to the bottom of the generated problem ticket file 304 and type in a comment or question in a separate comments box 370.

Once the user 140 has finished marking up the generated problem ticket file 304, the user 140 clicks on a “Send” button 372 located in the application window. This user action causes the conversion agent 150 to send the annotated problem ticket file to a server 108 where it is held in a queue that a technical support agent 142 can access via a client 144 when responding to problem tickets. In other examples, the user 140 can choose to save the annotated problem ticket file to a storage device, e.g., a memory of the user's computer 102, or print a hard copy of the annotated problem ticket file.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other embodiments are within the scope of the following claims. The following are examples for illustration only and not to limit the alternatives in any way. The techniques described herein can be performed in a different order and still achieve desirable results.

What is claimed is:

1. A method comprising:
displaying a portal page in a first graphical user interface window, the portal page comprising a content area for providing a view of an item of portal content associated with the portal page, wherein at least one other view of the item of portal content is not provided in the content area;
applying one or more conversion rules to the portal page to generate an electronic document; and
displaying the electronic document in a second graphical user interface window, wherein more than one view of the item of portal content is provided in the electronic document.

2. The method of claim 1, wherein all of the views of the item of portal content are provided in the electronic document.

3. The method of claim 1, wherein the portal page is defined by a portal page template comprised of a plurality of structure elements.

4. The method of claim 1, wherein at least one conversion rule is associated with a structure element, and applying the one or more conversion rules comprises:
identifying structure elements associated with the items of portal content provided in the content area of the portal page; and
redefining the identified structure elements based on corresponding conversion rules.

5. The method of claim 1, wherein the first graphical user interface window comprises a Web browser window and the second graphical user interface window comprises an application window.

6. The method of claim 1, wherein the second graphical user interface window comprises one or more editing tools, and wherein the method further comprises:
receiving, from a user, an input action to use one or more editing tools to add one or more annotation tags to the electronic document displayed in the second graphical user interface window.

7. The method of claim 6, wherein at least one annotation tag is drawn from a predefined set of tags comprising a text annotation tag, a line annotation tag, a square annotation tag, a circle annotation tag, a highlight annotation tag, an underline annotation tag, a strikeout annotation tag, and a popup annotation tag.

8. The method of claim 6, further comprising:
receiving, from the user, an input to take an action with respect to the electronic document; and
in response to the input, performing at least one of saving the electronic document, emailing the electronic document, and printing the electronic document.

9. A computer program product, tangibly embodied in an information carrier, the computer program product being operable to cause a machine to:
display a portal page in a first graphical user interface window, the portal page comprising a content area for providing a view of an item of portal content associated with the portal page, wherein at least one other view of the item of portal content is not provided in the content area;
apply one or more conversion rules to the portal page to generate an electronic document; and
display the electronic document in a second graphical user interface window, wherein more than one view of the item of portal content is provided in the electronic document.

10. The computer program product of claim 9, wherein all of the views of the item of portal content are provided in the electronic document.

11. The computer program product of claim 9, wherein the portal page is defined by a portal page template comprised of a plurality of structure elements.

12. The computer program product of claim 9, wherein at least one conversion rule is associated with a structure element, and wherein applying the one or more conversion rules comprises:
identifying structure elements associated with the items of portal content provided in the content area of the portal page; and
redefining the identified structure elements based on corresponding conversion rules.

13. The computer program product of claim 9, wherein the first graphical user interface window comprises a Web browser window and the second graphical user interface window comprises an application window.

14. The computer program product of claim 9, wherein the second graphical user interface window comprises one or more editing tools, and wherein the computer program product further causes the machine to:
receive, from a user, an input action to use one or more editing tools to add one or more annotation tags to the electronic document displayed in the second graphical user interface window.

15. The computer program product of claim 14, wherein at least one annotation tag is drawn from a predefined set of tags comprising a text annotation tag, a line annotation tag, a square annotation tag, a circle annotation tag, a highlight annotation tag, an underline annotation tag, a strikeout annotation tag, and a popup annotation tag.

16. The computer program product of claim 14, wherein the computer program product further causes the machine to:
receive, from the user, an input to take an action with respect to the electronic document; and
in response to the input, perform at least one of saving the electronic document, emailing the electronic document, and printing the electronic document.

17. A method comprising:
generating a portal page, the portal page comprising a content portion and a non-content portion;
converting the content portion to an electronic document; and
making the electronic document available to a technical support agent.

18. The method of claim 17, further comprising:
annotating the electronic document prior to making the electronic document available.

19. A computer program product, tangibly embodied in an information carrier, the computer program product being operable to cause a machine to:
generate a portal page, the portal page comprising a content portion and a non-content portion;
convert the content portion to an electronic document; and
make the electronic document available to a technical support agent.

20. The computer program product of claim 19, wherein the computer program product further causes the machine to:
annotate the electronic document prior to making the electronic document available.
